(19) United States
(12) Patent Application Publication
(10) Pub. No.: US 2023/0011000 A1
(43) Pub. Date: Jan. 12, 2023

(54) DIRECT CURRENT FAST CHARGING SYSTEMS WITH GRID TIED ENERGY STORAGE SYSTEMS

(71) Applicant: EnerSys Delaware Inc., Reading, PA (US)

(72) Inventors: Rui Zhou, Niskayuna, NY (US); Mohammed Kechmir, Wyomissing, PA (US); Pradeep Pant, Baltimore, MD (US)

(21) Appl. No.: 17/370,228

(22) Filed: Jul. 8, 2021

(51) Int. Cl. B60L 53/10; B60L 53/67; B60L 53/30; B60L 53/53; B60L 55/00

(52) U.S. Cl. CPC B60L 53/11; B60L 53/53; B60L 53/67; B60L 53/305; B60L 55/00; B60L 2210/30

(57) ABSTRACT

Direct current fast charging systems and devices with grid tied energy storage systems. As an example, a multi-unit charging system may include first and second charging stations, each of the first and second charging stations comprising a respective charger configured to transfer energy to an electric vehicle and a respective energy storage system configured to store energy, and a distribution network configured to connect each of the first and second charging stations to an electrical grid.

### TECHNICAL FIELD

The present disclosure relates to the electric charging of vehicles, and in particular relates to direct current fast charging systems with grid-tied energy storage systems.

### BACKGROUND

Batteries have become increasingly important, with a variety of industrial, commercial, and consumer applications. Of particular interest are power applications involving “deep discharge” duty cycles, such as motive power applications. The term “deep discharge” refers to the extent to which a battery is discharged during service before being recharged. By way of counter example, a shallow discharge application is one such as starting an automobile engine wherein the extent of discharge for each use is relatively small compared to the total battery capacity.

There is significant and increasing interest in consumer and commercial electric vehicles (EVs) that are propelled using electric motors supplied with power from “deep discharge” electric batteries. Examples of EVs include, but are not limited to, cars, vans, trucks, tractor units for semi-trailer trucks, sport utility vehicles (SUVs), airborne vehicles, and seaborne vehicles. Additional motive power applications that require deep discharge capability include Class 1 electric rider trucks, Class 2 electric narrow aisle trucks and Class 3 electric hand trucks. Purchasing trends and consumer surveys suggest that EVs may account for over 20% of the global vehicle market by 2030, with even higher adoption rates in some regions and countries.

The electric batteries in EVs are typically lithium-ion and lithium polymer, which offer high energy density compared to their weight. Other types of rechargeable batteries used in EVs include lead-based batteries and nickel-based batteries, as examples.

Many currently available EVs are charged using a plug or other wired connector. For example, some EVs can be coupled to standard electrical sockets via a supply cable, and an on-vehicle converter may convert alternating current (AC) grid power supplied from the socket into direct current (DC) power to charge the battery. Some EVs may be charged using an external charger that converts the grid power into the battery supply power. These chargers may integrate a large converter capable of supplying a higher amount of power (e.g., a higher voltage and/or current), reducing charging times. Various proprietary and open standards for implementing charging stations and charging cables are available or are being developed to increase the available infrastructure for charging EVs. Due to the forecasted growth in the EV market, the power requirements to charge EV will increase exponentially. However, if generation and transmission/distribution of power for EV chargers are unbalanced, transmission and distribution congestion may result.

### SUMMARY

Some aspects of the present disclosure provide a multi-unit charging system, which may include: first and second charging stations, each of the first and second charging stations comprising a respective charger configured to transfer energy to an electric vehicle and a respective energy storage system configured to store energy, and a distribution network configured to connect each of the first and second charging stations to an electrical grid.

In some aspects, the distribution network may include a grid-tie inverter configured to convert alternating current (AC) to direct current (DC). In some aspects, the distribution network may include a direct current (DC) distribution bus. In some aspects, the first and second charging stations may each include a local bus. In some aspects, each of the first and second charging stations may include a respective grid-tie inverter configured to convert alternating current (AC) to direct current (DC). In some aspects, the distribution network may include a multi-winding transformer. In some aspects, each of the first and second charging stations may include a respective dedicated direct current (DC) bus.

Some aspects of the present disclosure also provide a multi-unit charging system, which may include: first and second charging stations, each of the first and second charging stations comprising a respective charger configured to transfer energy to an electric vehicle, a respective grid-tie inverter, and a respective energy storage system configured to store energy, with each of the first and second charging stations further comprising a respective direct current (DC) distribution bus; and a multi-winding transformer configured to connect each of the first and second charging stations to an electrical grid.

In some aspects, the multi-unit charging system may include a third charging station comprising a respective charger configured to transfer energy to an electric vehicle and a respective energy storage system configured to store energy. In some aspects, each energy storage system may be configured to provide power to the electrical grid. In some aspects, the multi-unit charging system may include a gateway communicatively coupled to one or more of the chargers and to one or more of the energy storage systems, and a computing device communicatively coupled to the gateway via a network.

Some aspects of the present disclosure also provide a multi-unit charging system, which may include first and second charging stations, each of the first and second charging stations comprising a respective charger configured to transfer energy to an electric vehicle, a respective grid-tie inverter, and a respective energy storage system configured to store energy, with each of the first and second charging stations further comprising a respective direct current (DC) distribution bus; and a gateway communicatively coupled to each of the chargers, grid-tie inverters, and energy storage systems.

In some aspects, a computing device may be communicatively coupled to the gateway via a network. In some aspects, each energy storage system may be configured to provide power to a common electrical grid. In some aspects, the multi-unit charging system may include a multi-winding transformer configured to connect each of the first and second charging stations to the common electrical grid.

### BRIEF DESCRIPTION OF THE FIGURES

The accompanying drawings, which are incorporated in and constitute a part of the specification, illustrate embodiments of the inventive concepts and, together with the description, serve to explain principles of the inventive concepts.

FIG. 1 shows a typical multi-charger system having multiple chargers coupled to an AC power distribution bus.

FIG. 2 shows a typical multi-charger system having multiple chargers coupled to a DC power distribution bus.

FIG. 3 shows a multi-charger system having multiple charging stations coupled to a DC power distribution bus, where each charging station comprises an energy storage system, according to embodiments of the present disclosure.

FIG. 4 shows a multi-charger system having multiple charging stations coupled to a DC power distribution bus, where each charging station comprises an energy storage system and grid-tie inverter, according to embodiments of the present disclosure.

FIGS. 5 and 6 show aspects of energy management systems configured to provide control and communication within the multi-charger system of FIG. 3, according to embodiments of the present disclosure.

FIGS. 7 and 8 show aspects of energy management systems configured to provide control and communication within the multi-charger system of FIG. 4, according to embodiments of the present disclosure.

FIG. 9 shows various components of a computing device which may be used to implement one or more devices described herein.

### DETAILED DESCRIPTION

Herein, like reference numerals refer to corresponding parts throughout the drawings. Moreover, multiple instances of the same part may be designated by a common prefix separated from an instance number by a dash.

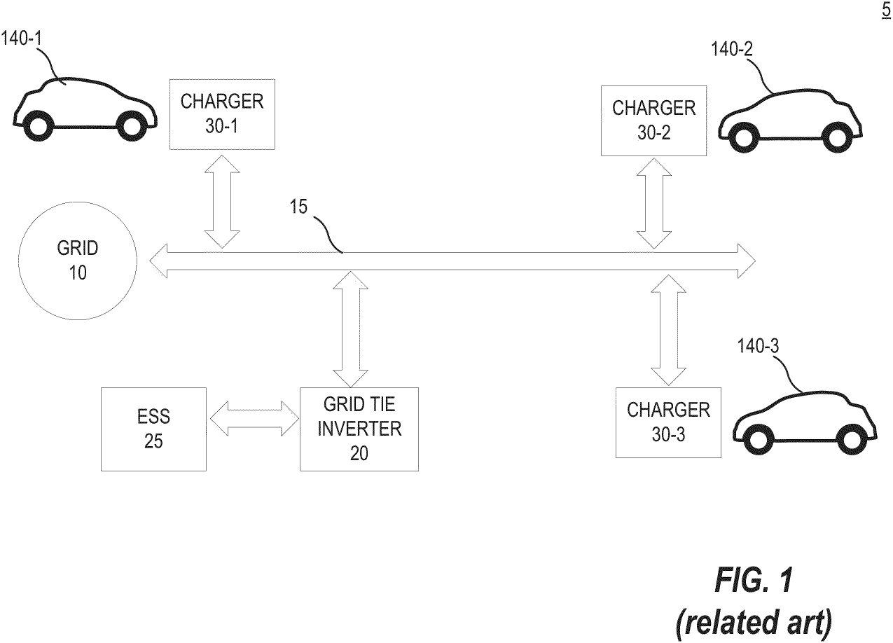

In some situations, multiple external chargers (discussed above) may be provided in a single location and tied to a common electrical bus, similar to a gas station or petrol station that has multiple pumps tied to a single reservoir of fuel of a certain octane rating. FIG. 1 shows a typical multi-charger system 5 having multiple chargers 30 that uses an AC distribution bus 15. Each charger 30 may be configured to charge one or more EVs 140. Power may be supplied to the chargers 30 (and thus, to the EVs 140) via the AC distribution bus 15 from an electrical grid 10. The electrical grid 10 may be a source of electrical power, such as an energy network that may provide, e.g., utility power, grid power, domestic power, mains electricity.

Also present in the multi-charger station 5 is an energy storage system (ESS) 25 configured to store electrical energy. Although electrical energy can be converted and stored in a variety of devices (e.g., potential energy storage devices, thermal energy storage devices), a common energy storage device within an ESS such as the ESS 25 is a battery device comprising one or more batteries and/or battery cells. The battery devices may be lithium-ion battery devices, as examples.

Typically, the battery devices or other electrical energy storage devices use DC or are configured to use DC. A grid-tie inverter 20 may be provided to convert between the AC provided from (or supplied to) the AC distribution bus 15 and the DC supplied to (or provided from) the ESS 25.

The chargers 30 typically operate at relatively short durations in which a relatively large amount of power is drawn from the electrical grid 10. As a result, a relatively large AC distribution bus 15 may be required to handle the large amount of drawn power, particularly when multiple chargers 30 are in use simultaneously. The ESS 25 is therefore typically employed to reduce a peak load on the electrical grid 10. The ESS 25 may act as supplementary power source and may supports the electrical grid 10 during peak power demand.

However, the present disclosure recognizes that the multi-charger system 5 of FIG. 1 has drawbacks, namely that the AC distribution bus 15 may need be sized to carry overall peak power of all the chargers 30 combined, even though situations where the chargers 30 are in simultaneous use may be minimal (or even non-existent). Additionally, the arrangement of the ESS 25 and grid-tie inverter 20 requires power conversion in both directions of power flow (i.e., to the ESS 25 and from the ESS 25), and some power will be lost in the conversion, even if the grid-tie inverter 20 is relatively efficient.

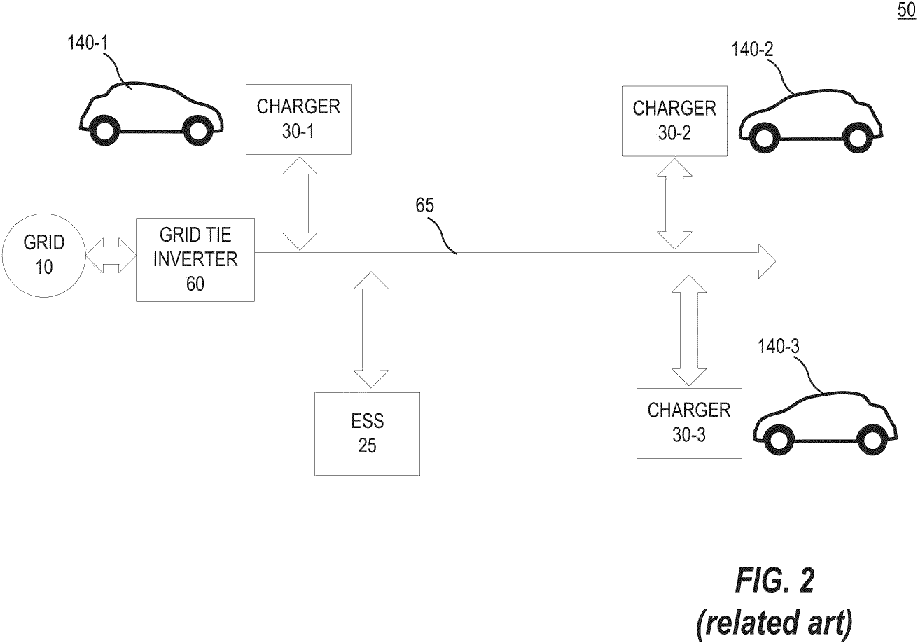

To address these drawbacks, DC “microgrid” multi-charger systems that use DC distribution buses have been proposed. FIG. 2 shows a typical multi-charger system 50 having multiple chargers 30 that uses an DC distribution bus 65, as opposed to the AC distribution bus 15 of FIG. 1. Each charger 30 may be configured to charge one or more EVs 40. Power may be supplied to the chargers 30 (and thus, to the EVs 140) via the DC distribution bus 65. A grid-tie inverter 60 may be provided to convert the AC provided from the electrical grid 10 to DC for the DC distribution bus 65, and vice versa (for example when the ESS 25 supports grid operations).

The arrangement of the ESS 25 and grid-tie inverter 60 reduces the amount of power conversion between AC and DC within the multi-charger system 50 (e.g., on the DC distribution bus 65 side of the grid-tie inverter 60). However, the present disclosure recognizes that the multi-charger system 50 of FIG. 2 also has drawbacks, namely that the DC distribution bus 65 may need be sized to carry overall peak power of all the chargers 30 combined, even though situations where all of the chargers 30 are in simultaneous use may be minimal (or even non-existent).

Transmission of high-power electrical energy over relatively long cable lengths may require expensive transmission and distribution infrastructure (e.g., expensive thick cabling), and may also result in high operating costs during high-usage energy periods. The present disclosure proposes systems and devices that may reduce the amount of peak load carried by a distribution bus within a multi-charger system, which may reduce capital and operating expenditures associated with electrical energy transmission and distribution within the multi-charger system. The multi-charger systems discussed herein may include a plurality of energy storage systems respectively associated with a plurality of chargers, which in some embodiments may be directly coupled thereto. The multi-charger systems may support fast chargers, which may require higher burst of power in shorter duration. Having an energy storage system tied to each charger may help reduce the peak currents hence simplifying DC bus system. Among the advantageous results is that such a system may enable the supply of the peak load demands while reducing overall load on the bus. Each energy storage system may be able to help supply peak power demands at periods of peak consumption, and then store energy at a slower pace during periods of reduced demand, essentially providing peak shaving to the multi-charger system. Additionally or alternatively, a cost of an interface with the electrical grid and/or a cost of internal distribution infrastructure may be lowered. Upgrading power transmission and distribution may require significant investment. This investment cost may be reduced by retrofitting existing charging systems with the systems and devices proposed herein. Overall power conversion can be optimized and peak demand can be managed. The presently described systems and devices thereof may be configured to operate in four quadrants of the active-reactive power plane, and may also provide grid support functions such as frequency regulation and volt/var support. Advantageous aspects of the present disclosure are furthered by a cloud-based energy management system also proposed herein, which may be configured to manage the multi-charger systems while providing charging energy for EVs and/or while providing grid support. Other advantages will be apparent to those skilled in the art.

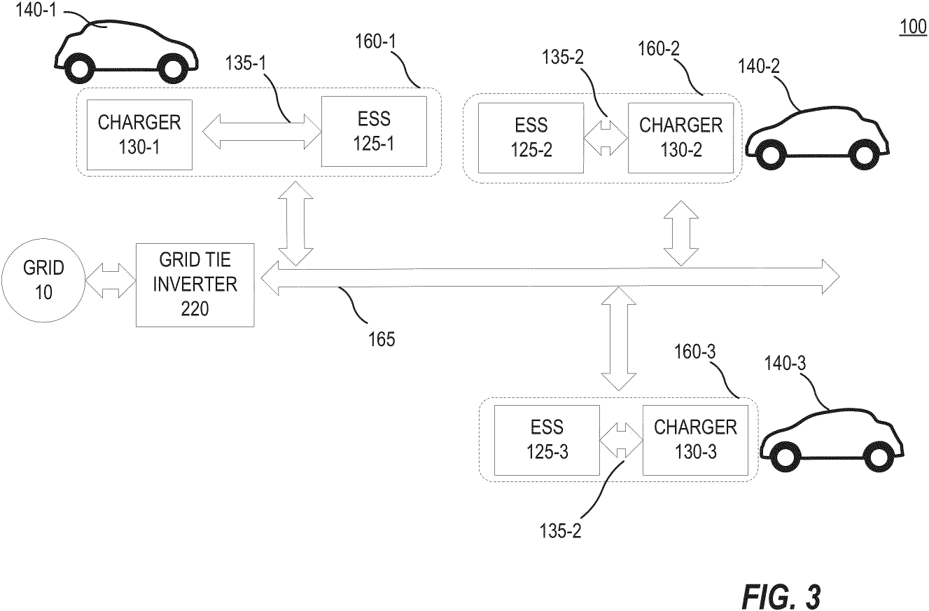

FIG. 3 shows a multi-charger system 100 having multiple charging stations 160 coupled to a DC power distribution bus 165, according to some embodiments of the present disclosure. Each of the multiple charging stations 160 includes a charger 130 and a respective ESS 125 coupled to the charger 130 of the charging station 160.

Each ESS 125 may include one or more components configured for storing energy. In preferred embodiments, each ESS 125 may include electrical batteries and/or capacitors for storage of electrical energy, but are not limited thereto and may include kinetic energy devices (e.g., flywheels and compressed air). Each ESS 125 may include inverters and converters configured to change stored energy into electrical energy and electrical energy into stored energy.

In some embodiments, each of the chargers 130 of the charging stations 160 may include a wired or “plug” charger configured to charge an EV 140 by coupling of a charging cable of the charger 130 to the EV 140. In some embodiments, the chargers 130 may include a charging system that is configured to supply power to the EV via inductive charging. For example, the EV 140 may be equipped with an on-board inductive charging system that includes an on-board coil on the underside or ground-facing side of the EV 140. An off-board inductive charging system of each charger 130 may be installed in a respective parking location for the EVs 140, such as a parking spot, garage stall, designated charging area, or the like. The off-board inductive charging system 110 includes an off-board coil, which may be positioned such that it will be aligned with the on-board coil of the EV 140 when the EV 140 is parked in the parking location. During a charging session, energy may be transferred from the charger 130 to the EV 140 through inductive coupling via the coils. Different types of chargers 130 may be present in the multi-charger system 100.

Each charger 130 may also have or may also be connected to a controller (not shown) that may be used by a user to initiate charging of the EV 140 and perform other actions with respect to the respective charger 130. For example, the controller may be used to provide payment information as part of purchasing charging services for charging of the EV 140, subscriber information as part of indicating a user or subscriber of charging services for charging the EV 140, or other information that may be used to facilitate charging of the EV 140.

Each charger 130 may be a “fast” charger 130 that includes a DC/DC converter therein capable of receiving a voltage from a local bus 135 of the respective charging station 160. The DC/DC converter may be configured to convert the input DC power signal having a first current level and first voltage level to an output DC power signal having a second current level and/or second voltage level, thereby supplying a higher amount of power to reduce charging times.

The local bus 135 may couple each charger 130 to the respective ESS 125 of the charging station 160. For example, for a first charging station 160-1, the first charger 130-1 thereof may be coupled to the first ESS 125-1 by the first local bus 135-1. The local bus 135 may be coupled galvanically or via a DC/DC converter to the DC distribution bus 165.

A grid-tie inverter 220 may be provided to convert the AC provided from the electrical grid 10 to DC for the DC distribution bus 165, and vice versa.

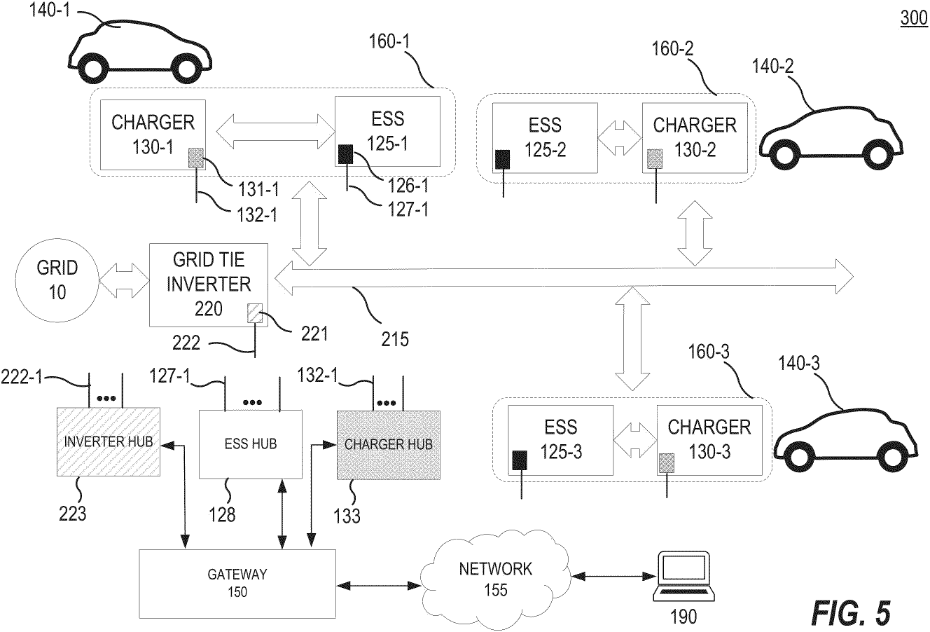

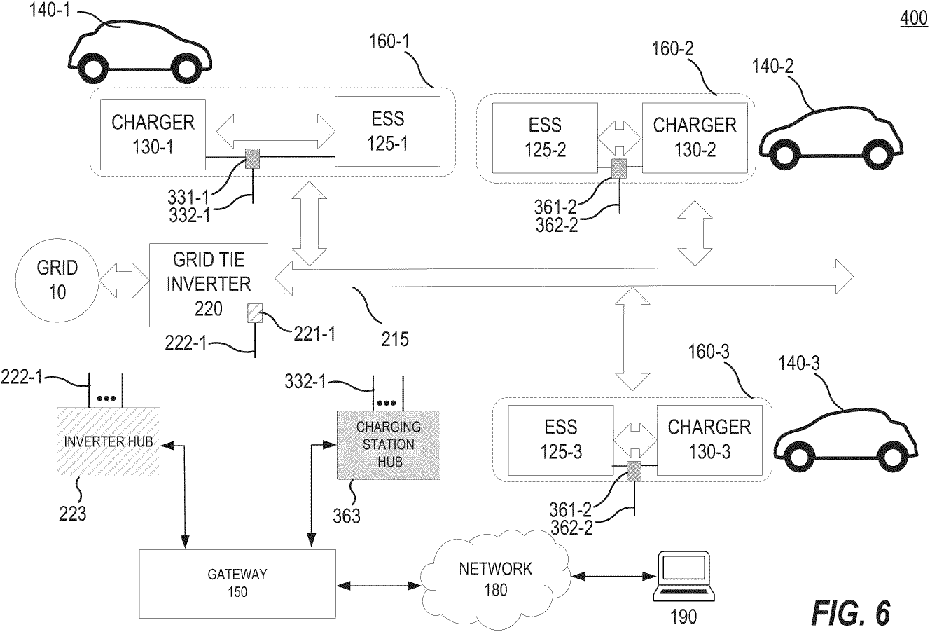

Each ESS 125 may be configured to supply power to the charger 130 of the charging station 160. In addition to providing local power to the respective charger 130, the plurality of ESSs 125 may be configured to provide power elsewhere within the multi-charger system 100 as needed. For example, during periods of peak load on the electrical grid 10, a first ESS 125-1 may supply power to one or more of the first charger 130-1, second charger 130-2, third charger 130-3 and/or the electrical grid 10 (via grid tie inverter 220). In some embodiments, the configuration of the ESS 125 to supply power to one or more of the first charger 130-1, second charger 130-2, third charger 130-3 and/or the electrical grid 10 may be performed by or via a controller discussed further below with respect to FIGS. 5 and 6.

Although not shown in FIG. 3, in some embodiments one or more power sources (e.g., a solar power production system configured to produce electrical energy from solar energy) may be tied to the DC distribution bus 165.

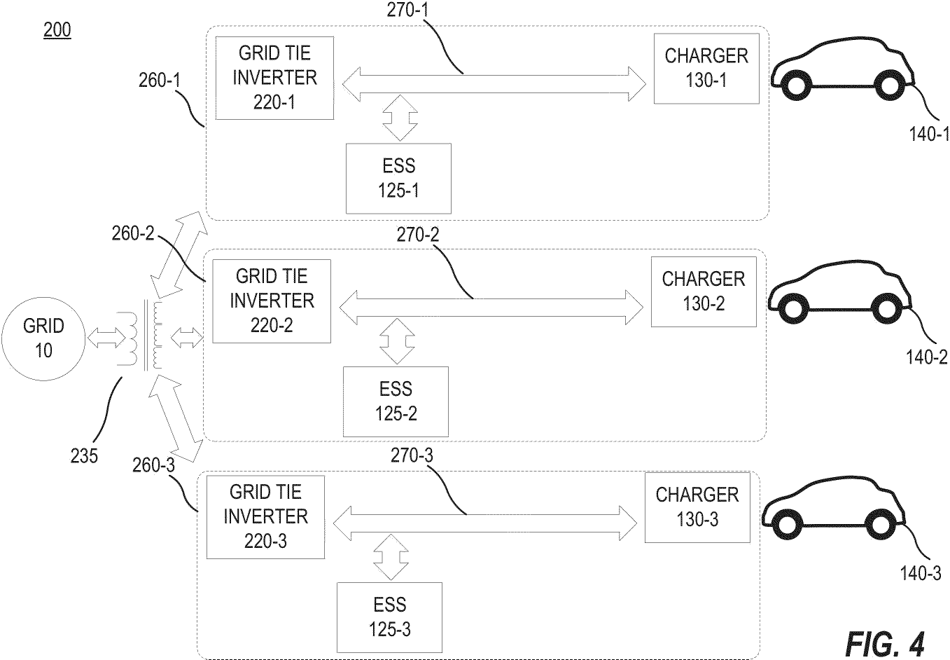

FIG. 4 shows a multi-charger system 200 having multiple charging stations 260 for charging of EVs 140. In addition to a charger 130, each charging station 260 may include a dedicated DC bus 270, a local energy storage system 125, and a local grid-tie inverter 220. according to embodiments of the present disclosure. The chargers 130 of FIG. 4 and the energy storage systems 125 may be similar to those discussed with respect to FIG. 3, and duplicate discussion thereof is omitted herein in the interest of brevity. Additionally, the local grid-tie inverters 220 (that is, the first grid-tie inverter 220-1, the second grid tie inverter 220-2, and the third grid tie inverter 220-3) may each be similar to the single grid tie inverter 220 of FIG. 3, in that each is configured to convert between AC and DC.

Each charging station 260 may be tied to the electrical grid 10 via a respective winding of a multi-winding transformer 235, which in some embodiments may be a multi-phase multi-winding transformer. The charger 130 of each charging station 260 may be configured to draw power from the electrical grid 10 and/or the respective ESS 125 via the dedicated DC bus 270 of the charging station 260. The arrangement of the charging stations 260 may not require that the chargers be galvanically isolated, which may reduce cost and increase system efficiency.

In some embodiments, the charger stations 160 and 260 of FIG. 3 and FIG. 4 may be containerized (e.g., the components thereof may be within a unitary housing having connectors on an exterior surface thereof to the components within the housing).

FIGS. 5 and 6 show aspects of an energy management system configured to provide control and communication within the multi-charger system of FIG. 3, according to embodiments of the present disclosure. In some embodiments, control and communication of the components of the multi-charger system may be performed via a cloud-based energy management system, which may be configured to manage the multi-charger systems while the chargers provide charging energy for EVs and/or while the ESSs provide grid support.

FIG. 5 shows a multi-charger system 300, which may be similar to the multi-charger system 100 of FIG. 3, except that charger controllers 131, ESS controllers 126, and grid tie inverter controller 221 are shown in FIG. 5. The multi-charger system 300 of FIG. 5 also includes a charger controller hub 133, an ESS controller hub 128, a grid tie inverter controller hub 223, a gateway 150, a network 155, and a computing device 190.

The charger controllers 131 may be coupled via respective communication links 132 to the charger controller hub 133. The ESS controllers 126 may be coupled via respective communication links 127 to the ESS controller hub 128. The grid tie controller 221 may be coupled to the grid tie inverter controller hub 223 via a respective communication link 222. Although only one grid tie inverter 220 is shown in FIGS. 3 and 5, it is to be understood that in some embodiments and arrangements, multiple grid tie inverters 220 may be present in a multi-charger system, with each grid tie inverter 220 serving multiple charging stations 160. In other words, the figures and description herein are not limited to the specific numbers of devices or components shown in the figures.

Each charger controller 131, each ESS controller 126, and each grid tie controller 221 may be configured to control operational aspects of the respective charger 130, ESS 125, and grid tie 220. In some embodiments, the control may be real time control (e.g., real-time voltage control, real-time current control, and/or real-time power mode control) of the respective charger 130, ESS 125, and grid tie 220. In some embodiments, each charger controller 131 may be, and/or may accept the user inputs and perform the operations of the controller discussed with reference to, but not shown in, FIG. 3.

The charger controller hub 133, ESS controller hub 128, and grid tie controller hub 223 may be communicatively coupled with a gateway 150 configured to provide network connectivity to the charger controller hub 133, ESS controller hub 128, and grid tie controller hub 223. In some embodiments, one or more of the charger controller hub 133, ESS controller hub 128, and grid tie controller hub 223 may be provided with network connectivity, and thus in some embodiments the gateway 150 may be omitted. Deployment of a single gateway 150 or a group of multiple gateways 150, and deployment of the charger controller hub 133, the ESS controller hub 128, and the grid tie controller hub 223 may permit technology agnostic communication, may prevent or reduce addressing of malicious or ill-formed data packets directly to the components of the charging stations 160 and/or the grid tie inverter 220, and may help in facilitating retrofitted deployments, given that field sites may have variable electrical and/or signal transmission characteristics.

The network 155 may include a local network, a wireless, coaxial, fiber, or hybrid fiber/coaxial distribution system, a Wi-Fi or Bluetooth network, or any other desired network. The network 155 may be made up of one or more subnetworks, each of which may include interconnected communication links of various types, such as coaxial cables, optical fibers, wireless links, and the like. The network 155 and/or the subnetworks thereof may include, for example, networks of Internet devices, telephone networks, cellular telephone networks, fiber optic networks, local wireless networks (e.g., WiMAX, Bluetooth), satellite networks, and any other desired network, and each device of FIG. 5 may include the corresponding circuitry needed to communicate over the network 155, and to other devices on the network. Although the devices of the multi-charger system 300 of FIG. 5 are illustrated as communicating over a common network 155, in some embodiments various point-to-point or device-to-device networks or communication links may be used in addition to or alternatively from the common network 155 for example to communicate data between a first device (e.g., the first charger controller 131-1 of the first charger 130-1) and a second device (e.g., the computing device 190). The communication links 127, 132, and 222 may be wired or wireless communication links.

The computing device 190 may include a display device for displaying measurements, estimations, and/or predictions (e.g., graphically, tabularly, and/or numerically) of properties of the chargers 130, ESS 125, and/or grid tie inverter 220, as communicated by the respective controllers 131, 126, and 221 thereof. The properties displayed and the values of the properties displayed may include derived properties or values and/or analyzed properties or values. In some embodiments, the computing device 190 may include input devices configured to accept user input for manipulating the displayed data, such as the desired type of output/display, user settings (e.g., temperature values provided in Celsius or Fahrenheit) and so on. The computing device 190 may also be configured to accept user input in the form of commands to be communicated to the chargers 130, ESS 125, and/or grid tie inverter 220. For example, the user input may include a command that a selected one or more than one charger 130, ESS 125, and/or grid tie inverter 220 is to be activated or deactivated; that a feature (e.g., grid support) or property (e.g., maximum output voltage) is to be enabled, disabled, or modified; or that software or firmware of the selected devices is to be updated. The computing device 190 may also be configured to generate and transmit any of the commands described above (or any other command) to the chargers 130, ESS 125, and/or grid tie inverter 220 autonomously without user input.

In some embodiments, described components of the charger controller hub 133, ESS controller hub 128, grid tie controller hub 223, gateway 150, or computing device 190 may be implemented in hardware or software, and/or may be provided via virtualization software that creates an abstraction layer that enables hardware elements, such as processors, memory, and storage to be divided into multiple system virtual machines (VMs). Such virtualization software may provide system-level virtualization where each VM runs its own operating system, or operating-system level virtualization technologies where application code and application code dependencies are bundled together in a single package. This package is often called a container, although specific nomenclature may be implementation-dependent. Multiple containers may be run on a single hardware instance or a single VM.

FIG. 6 shows a multi-charger system 400, which may be similar to the multi-charger system 300 of FIG. 5, except that charger controllers 131 and ESS controllers 126 may be omitted in favor of charging station controllers 331, that are communicatively coupled to a charging station hub 363 via respective communication links 332. The charger controller hub 133 and ESS controller hub 128 may be omitted in favor of the charging station hub 363. The communication and control aspects described above with reference to the ESS controllers 126 and charger controllers 131 may instead be partially or completely provided by the charging station controllers 331. In some embodiments, the ESSs 125 and the chargers 130 may have controllers that communicate with the charging station controller 331.

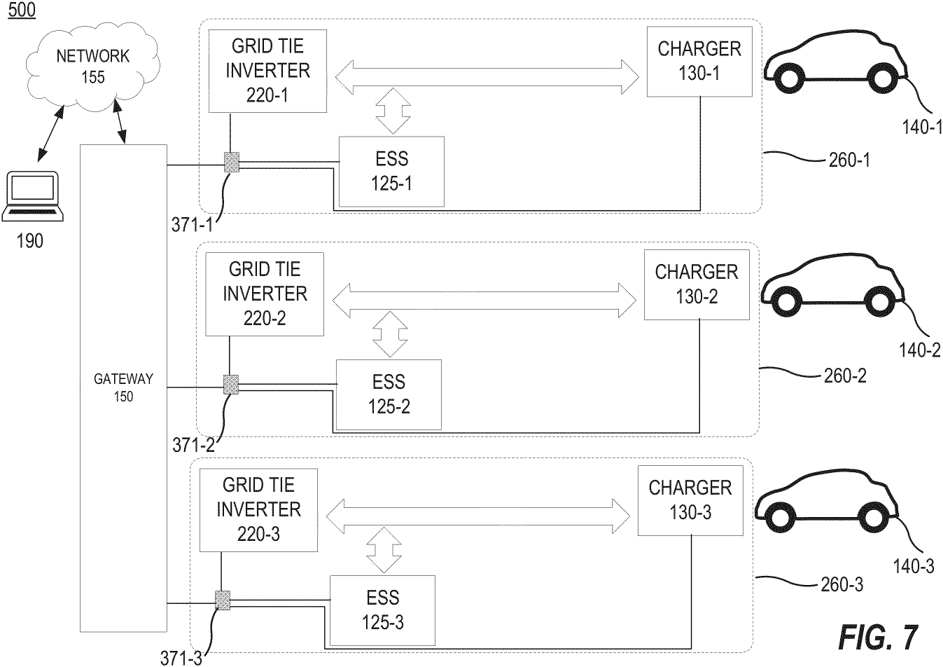

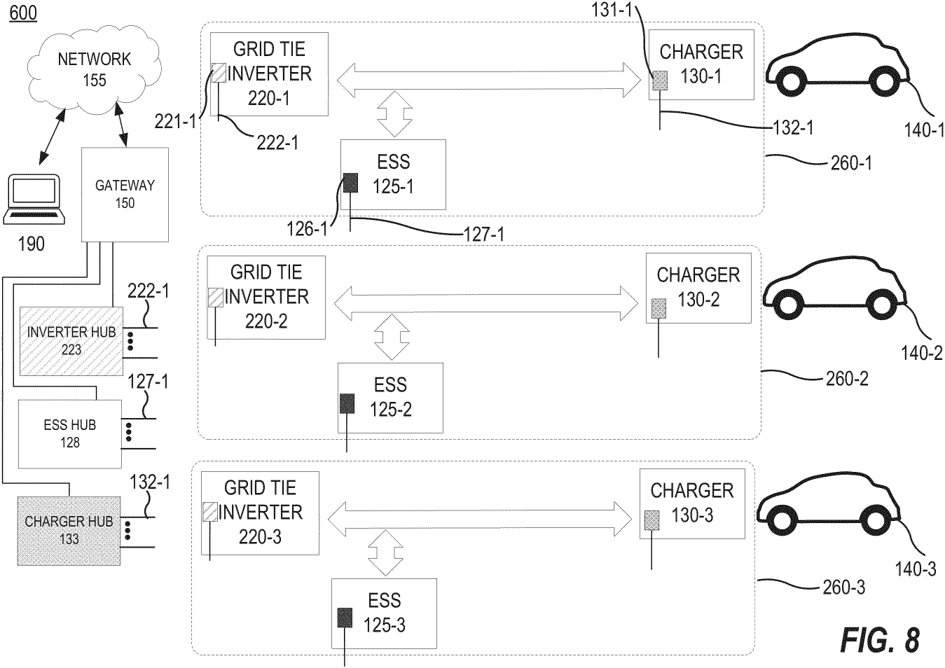

FIGS. 7 and 8 show aspects of energy management systems configured to provide control and communication within the multi-charger system of FIG. 4, according to embodiments of the present disclosure. FIG. 7 shows a multi-charger system 500, which may be similar to the multi-charger system 200 of FIG. 4, except that charger station controllers 371 are shown. A gateway 150, a network 155, and a computing device 190 are also present in the multi-charger system 500. Each of these components may be functionally similar to the gateway 150, the network 155, and the computing device 190 of FIG. 5, and duplicate description thereof is omitted herein in the interest of brevity. The communication and control aspects described above with reference to the grid tie controller 221, the ESS controllers 126, and the charger controllers 131 may instead be partially or completely provided by the charging station controllers 371. In some embodiments, the grid tie inverters 220, the ESSs 125, and the chargers 130 may have controllers that communicate with the charging station controller 331.

FIG. 8 shows a multi-charger system 600, which may be similar to the multi-charger system 200 of FIG. 4, except that charger controllers 131, ESS controllers 126, and grid tie inverter controller 221 are shown in FIG. 8. The multi-charger system 600 of FIG. 5 also includes a charger controller hub 133, an ESS controller hub 128, a grid tie inverter controller hub 223. A gateway 150, a network 155, and a computing device 190 are also present in the multi-charger system 500. Each of these components may be functionally similar to the components described with reference to FIG. 5, and duplicative description thereof is omitted in the interest of brevity.

Various aspects of the multi-charger systems 100-600 that are described and shown with reference to a first of the multi-charger systems 100-600 but not explicitly described and shown with reference to a second of the multi-charger systems 100-600 may nevertheless be included in an implementation of the second multi-charger system 100-600.

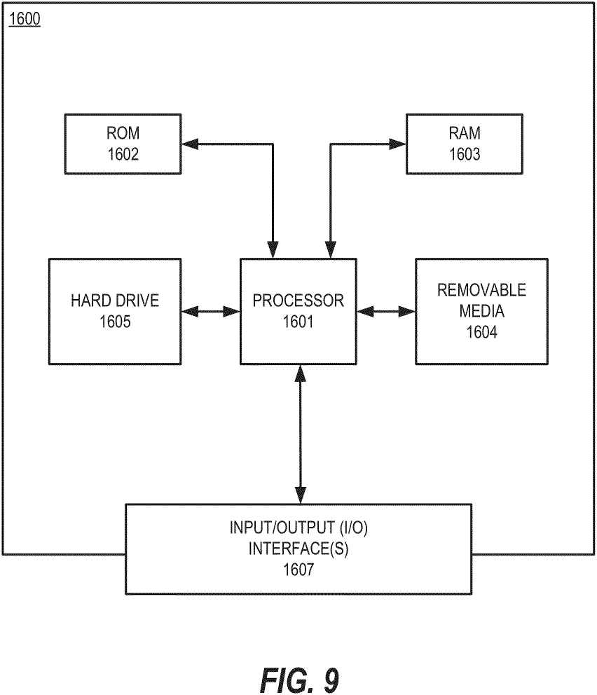

FIG. 9 illustrates various components of a computing device 1600 which may be used to implement one or more of the devices herein, including the controllers and other computing devices in the systems 5, 50, 100, 200, 300, 400, 500, and 600. FIG. 9 illustrates hardware elements that can be used in implementing any of the various computing devices discussed herein. In some aspects, general hardware elements may be used to implement the various devices discussed herein, and those general hardware elements may be specially programmed with instructions that execute the algorithms discussed herein. In special aspects, hardware of a special and non-general design may be employed (e.g., ASIC or the like). Various algorithms and components provided herein may be implemented in hardware, software, firmware, or a combination of the same.

A computing device 1600 may include one or more processors 1601, which may execute instructions of a computer program to perform any of the features described herein. The instructions may be stored in any type of computer-readable medium or memory, to configure the operation of the processor 1601. For example, instructions may be stored in a read-only memory (ROM) 1602, random access memory (RAM) 1603, removable media 1604, such as a Universal Serial Bus (USB) drive, compact disk (CD) or digital versatile disk (DVD), floppy disk drive, or any other desired electronic storage medium. Instructions may also be stored in an attached (or internal) hard drive 1605. The computing device 1600 may be configured to provide output to one or more output devices (not shown) such as printers, monitors, display devices, and so on, and receive inputs, including user inputs, via input devices (not shown), such as a remote control, keyboard, mouse, touch screen, microphone, or the like. The computing device 1600 may also include input/output interfaces 1607 which may include circuits and/or devices configured to enable the computing device 1600 to communicate with external input and/or output devices (such as computing devices on a network) on a unidirectional or bidirectional basis. The components illustrated in FIG. 9 (e.g., processor 1601, ROM storage 1602) may be implemented using basic computing devices and components, and the same or similar basic components may be used to implement any of the other computing devices and components described herein. For example, the various components herein may be implemented using computing devices having components such as a processor executing computer-executable instructions stored on a computer-readable medium, as illustrated in FIG. 9. Some components of the computing device 1600 may be omitted in some implementations.

The inventive concepts provided by the present disclosure have been described above with reference to the accompanying drawings and examples, in which examples of embodiments of the inventive concepts are shown. The inventive concepts provided herein may be embodied in many different forms than those explicitly disclosed herein, and the present disclosure should not be construed as limited to the embodiments set forth herein. Rather, the examples of embodiments disclosed herein are provided so that this disclosure will be thorough and complete, and will fully convey the scope of the inventive concepts to those skilled in the art. Like numbers refer to like elements throughout.

Some of the inventive concepts are described herein with reference to block diagrams and/or flowchart illustrations of methods, apparatus (systems) and/or computer program products, according to embodiments of the inventive concepts. It is understood that one or more blocks of the block diagrams and/or flowchart illustrations, and combinations of blocks in the block diagrams and/or flowchart illustrations, can be implemented by computer program instructions. These computer program instructions may be provided to a processor of a general-purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks. These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the inventive concepts may be embodied in hardware and/or in software (including firmware, resident software, micro-code, etc.). Furthermore, embodiments of the present inventive concepts may take the form of a computer program product on a computer-usable or computer-readable non-transient storage medium having computer-usable or computer-readable program code embodied in the medium for use by or in connection with an instruction execution system.

The computer-usable or computer-readable medium may be, for example but not limited to, an electronic, optical, electromagnetic, infrared, or semiconductor system, apparatus, or device. More specific examples (a non-exhaustive list) of the computer-readable medium would include the following: an electrical connection having one or more wires, a portable computer diskette, a random-access memory (RAM), a read-only memory (ROM), an erasable programmable read-only memory (EPROM or Flash memory such as an SD card), an optical fiber, and a portable compact disc read-only memory (CD-ROM).

Well-known functions or constructions may not be described in detail for brevity and/or clarity.

The terms first, second, etc. may be used herein to describe various elements, but these elements should not be limited by these terms. These terms are only used to distinguish one element from another. For example, a first element could be termed a second element, and, similarly, a second element could be termed a first element, without departing from the scope of the present inventive concepts. As used herein, the term “and/or” includes any and all combinations of one or more of the associated listed items. As used herein, the singular forms “a”, “an” and “the” are intended to include the plural forms as well, unless the context clearly indicates otherwise. It should be further understood that the terms “comprises,” “comprising,” “includes,” and/or “including” when used herein, specify the presence of stated features, operations, elements, and/or components, but do not preclude the presence or addition of one or more other features, operations, elements, components, and/or groups thereof.

When an element is referred to as being “on” another element, it can be directly on the other element or intervening elements may also be present. In contrast, when an element is referred to as being “directly on” another element, there are no intervening elements present. When an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Aspects and elements of all of the embodiments disclosed above can be combined in any way and/or combination with aspects or elements of other embodiments to provide a plurality of additional embodiments. Although a few exemplary embodiments of the inventive concepts have been described, those skilled in the art will readily appreciate that many modifications are possible in the exemplary embodiments without materially departing from the novel teachings and advantages of the inventive concepts provided herein. Accordingly, all such modifications are intended to be included within the scope of the present application as defined in the claims.

What is claimed is:

1. A multi-unit charging system, comprising:
first and second charging stations, each of the first and second charging stations comprising a respective charger configured to transfer energy to an electric vehicle and a respective energy storage system configured to store energy, and
a distribution network configured to connect each of the first and second charging stations to an electrical grid.

2. The multi-unit charging system of claim 1, wherein the distribution network comprises a grid-tie inverter configured to convert alternating current (AC) to direct current (DC).

3. The multi-unit charging system of claim 1, wherein the distribution network comprises a direct current (DC) distribution bus.

4. The multi-unit charging system of claim 1, wherein the first and second charging stations each comprise a local bus.

5. The multi-unit charging system of claim 1, wherein each of the first and second charging stations comprises a respective grid-tie inverter configured to convert alternating current (AC) to direct current (DC).

6. The multi-unit charging system of claim 5, wherein the distribution network comprises a multi-winding transformer.

7. The multi-unit charging system of claim 5, wherein each of the first and second charging stations comprises a respective dedicated direct current (DC) bus.

8. The multi-unit charging system of claim 1, further comprising a third charging station comprising a respective charger configured to transfer energy to an electric vehicle and a respective energy storage system configured to store energy.

9. The multi-unit charging system of claim 1, wherein each energy storage system is configured to provide power to the electrical grid.

10. The multi-unit charging system of claim 1, further comprising a gateway communicatively coupled to one or more of the chargers and to one or more of the energy storage systems.

11. A multi-unit charging system, comprising:
first and second charging stations, each of the first and second charging stations comprising a respective charger configured to transfer energy to an electric vehicle, a respective grid-tie inverter, and a respective energy storage system configured to store energy, with each of the first and second charging stations further comprising a respective direct current (DC) distribution bus; and
a multi-winding transformer configured to connect each of the first and second charging stations to an electrical grid.

12. The multi-unit charging system of claim 11, further comprising a third charging station comprising a respective charger configured to transfer energy to an electric vehicle and a respective energy storage system configured to store energy.

13. The multi-unit charging system of claim 11, wherein each energy storage system is configured to provide power to the electrical grid.

14. The multi-unit charging system of claim 11, wherein each charging station comprises a charging station controller, the multi-unit charging system further comprising a gateway communicatively coupled to the charging station controllers.

15. The multi-unit charging system of claim 14, further comprising a computing device communicatively coupled to the gateway via a network.

16. A multi-unit charging system, comprising:
first and second charging stations, each of the first and second charging stations comprising a respective charger configured to transfer energy to an electric vehicle, a respective grid-tie inverter, and a respective energy storage system configured to store energy, with each of the first and second charging stations further comprising a respective direct current (DC) distribution bus; and
a gateway communicatively coupled to each of the chargers, grid-tie inverters, and energy storage systems.

17. The multi-unit charging system of claim 16, further comprising a computing device communicatively coupled to the gateway via a network.

18. The multi-unit charging system of claim 16, further comprising a third charging station comprising a respective charger configured to transfer energy to an electric vehicle and a respective energy storage system configured to store energy.

19. The multi-unit charging system of claim 16, wherein each energy storage system is configured to provide power to a common electrical grid.

20. The multi-unit charging system of claim 19, further comprising a multi-winding transformer configured to connect each of the first and second charging stations to the common electrical grid.
